(19) United States
(12) Patent Application Publication
(10) Pub. No.: US 2021/0055996 A1
(43) Pub. Date: Feb. 25, 2021

(54) MIGRATION OF BACKUP DATA

(71) Applicant: EMC Corporation, Hopkinton, MA (US)

(72) Inventors: Kenneth William Owens, Burlington (CA); Vladmir Mandic, San Jose, CA (US); Thomas Papadakis, Burlington (CA); Dorota Zak, Mississauga (CA); Adrian Dobrean, Oakville (CA)

(73) Assignee: EMC Corporation, Hopkinton, MA (US)

(21) Appl. No.: 14/167,689

(22) Filed: Jan. 29, 2014

(51) Int. Cl. G06F 11/14

(52) U.S. Cl. CPC G06F 11/1448

(57) ABSTRACT

Systems and methods for migrating backups are disclosed. A backup can be transferred from a standalone backup system and incorporated into the backups maintained by a centralized backup system.

### BACKGROUND

In general, backup operations for a clients' data are performed in conjunction with a backup server. The backup server is configured to store and manage the data backed up from the clients. When it is necessary to restore data from one of the backups, the backup server is also involved in the restore operation. The backup server can facilitate locating and identifying the appropriate backup for the restore operation to a particular client.

It is also possible to backup a client's data on a backup device (a standalone system) without involving a backup server. However, there are situations where it becomes desirable to migrate the backup data of a standalone system to a server-based backup system (a centralized backup management system).

There are various challenges, however, in migrating backups from one system to another system. For example, many backups consume large amounts of storage. A database, for instance, can consume terabytes or more of disk space. As a result, copying the backup data from the backup device to a server-based backup system can adversely impact the performance of the backup device while the copy operation is being performed. In addition, a copy operation can require a large amount of time. Systems and methods are needed that allow a client to migrate backup data from a standalone backup system to a centralized backup system.

### BRIEF DESCRIPTION OF THE DRAWINGS

In order to describe the manner in which at least some of the advantages and features of the invention can be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 illustrates an example of a system for migrating backups that includes a standalone backup system and a centralized backup system;

FIG. 2 illustrates an example of clients that can backup data to a standalone backup system and/or a centralized backup system and of a system that can migrate the backup data;

FIG. 3 illustrates an example of a system that is configured to migrate a backup from a standalone backup system to a centralized backup system;

FIG. 4 illustrates an example of a backup that has been migrated from a standalone backup system to a centralized backup system;

FIG. 5 illustrates and example of backups before and after migration; and

FIG. 6 is an example of a method for migrating backup data to a centralized backup system.

### DETAILED DESCRIPTION

Embodiments of the invention relate to systems and methods for backing up clients and to backing up data of the clients. More particularly, embodiments of the invention relate to systems and methods for migrating a backup from a standalone backup system to a centralized backup system. Embodiments of the invention may further relate to restoring a backup that has been migrated from the standalone backup system to the centralized backup system.

Embodiments of the invention can be implemented in systems that include standalone backup systems and in situations where the standalone backup systems are being incorporated into an environment that supports a centralized backup system or in environments that already include both types of backup systems.

Generally, the migration of a backup is completed once both the data of the backup and the metadata associated with the backup have been migrated and incorporated into the destination system. Advantageously, embodiments of the invention may not actually perform a copy of the data included in the backup. In other words, it may not be necessary to scan and copy the data in the initial backup. Rather, links to the data may be generated by either system. The links point to or identify the actual data and can be treated like files within the centralized backup system.

For example, a standalone backup system may store backups such that the data is de-duplicated. For example, two backups may each contain some of the same data. Because the data is de-duplicated, the actual data associated with two backups. From a perspective of a file system, the file system may be able to present two files even though both correspond to the same blocks of data. In this sense, the files are linked. In one example, data can be linked by creating a pointer to the actual data. In this example, one backup may contain the actual data blocks while the other backup may point to the actual data blocks. In another example, both backups may be configured to point to the same data block.

The standalone backup system may maintain a file system that can be presented to another device. The file system can present a data even though only a link is presented. When a backup is migrated, the data stored in the standalone backup system is not actually moved. In one example, a link is generated or reconfigured.

In the context of migrating a backup from a standalone backup system to a centralized backup system, the standalone backup system may provide data that appears to be a file even if it is actually a link to the actual underlying data.

The metadata of a backup may be physically moved or copied. In one example, the metadata (e.g., indexing information) is copied into and incorporated into the metadata maintained by the centralized backup system.

Because the storage device associated with the standalone backup system may be part of the same environment or part of the same network as the centralized backup system, the backup maintained by the centralized backup system can link to the data rather than copy the data. In addition, the data included in the backup may be de-duplicated before the migration and/or after the migration of the backup from the standalone backup system to the centralized backup system.

For example, the standalone backup system may store de-duplicated backups. When the backups are migrated, they are migrated into a system that stores additional data. As a result, further de-duplication may occur with respect to the new data that has been introduced into the centralized backup system.

Further, when a backup is migrated from a standalone backup system to a centralized backup system, there are aspects of the migration may be performed by the centralized backup system and may involve situations where the centralized backup system invokes or uses features of the standalone backup system. However, it is also possible for the standalone backup system to perform the migration by invoking features of the centralized backup system. Generally, embodiments of the invention relate to systems and methods where the centralized backup system and the standalone backup system cooperate to migrate backups from the standalone backup system to the centralized backup system.

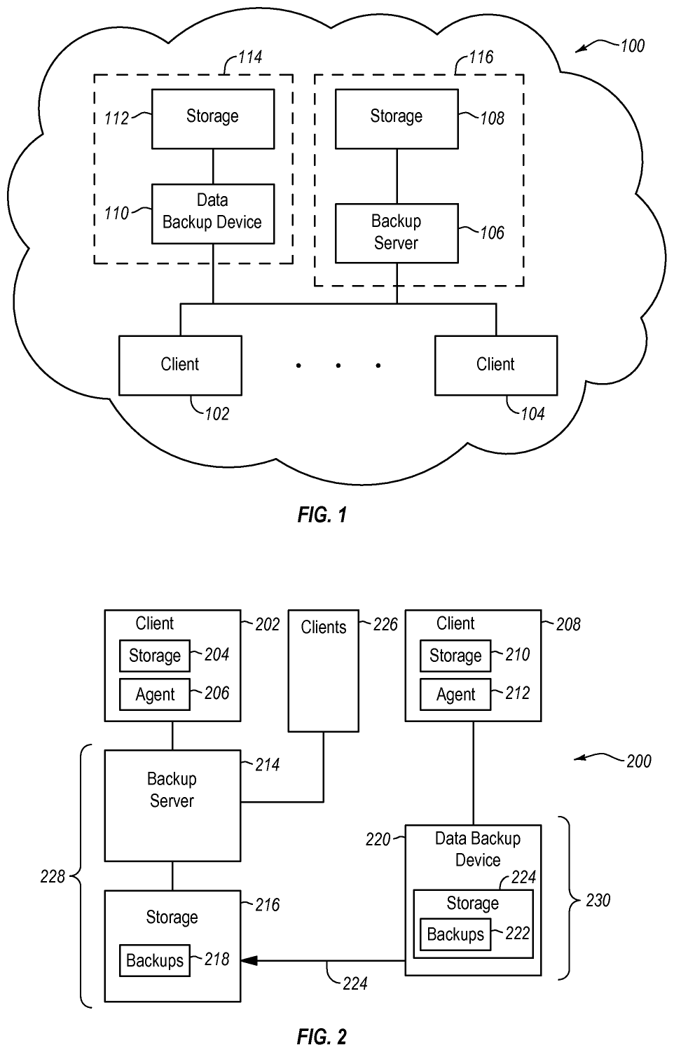

FIG. 1 illustrates an example of an environment or system that includes a standalone backup system and a centralized backup system. FIG. 1 illustrates a network 100 that includes multiple clients. The clients are illustrated as client 102 and client 104. In context, the clients 102 and 104 may be workstation computers, servers (e.g., file servers, email servers), a database, a storage device, a storage array, or the like or combination thereof. The clients 102 and 104 are therefore associated with data that is backed up.

FIG. 1 also illustrates that the network 100 includes a standalone backup system 114 and a centralized backup system 116. The standalone backup system 114 includes a data backup device 110 that is associated with storage 112. The storage 112 may be incorporated into the data backup device 110 or separate from the data backup device 110. The storage 112 may be a hard drive, a disk array, network attached storage, or other type of storage device.

The standalone backup system 114 can be connected with one or more clients such as the clients 102 and 104. The backup of the client 102, in the context of the standalone backup system 114, is separate and independent of the backup of the client 104. At the same time, the standalone backup system 114 could de-duplicate the data with respect to the backups of both the client 102 and 104. Alternatively, the standalone backup system 114 may de-duplicate the backups of the client 102 and separately de-duplicate the backups of the client 104.

FIG. 1 also illustrates a centralized backup system 116 that includes a backup server 106 and a storage 108. The storage 108 may be integrated with the backup server 106 or separate therefrom. The storage 108 may be a hard drive, a disk array, network attached storage, or the like or other storage device.

The centralized backup system 116 is an example of a system that can coordinate backups of multiple clients. The centralized backup system 116 is not required to backup every client in the network 100, however.

In one example, the standalone backup system 114 may use direct attached storage. The standalone backup system 114 may create a local backup of a specific machine or client. The centralized backup system 116 may backup multiple clients of machines in a cloud, in a datacenter, or over a network. Once the backups created by the standalone backup system 114 are migrated to the centralized backup system 116, all of the functionality of the centralized backup system 116 can be performed on the migrated backup. In FIG. 1, the standalone backup system 114 is configured to migrate backups to the centralized backup system 116.

FIG. 2 illustrates an example of clients that can backup data to a standalone backup system or a centralized backup system. FIG. 2 illustrates a client 202, a client 208, and clients 226. The client 202 is associated with storage 204 and an agent 206. The client 208 mat be similarly associated with storage 210 and an agent 212.

In this example, the client 202 and other clients 226 are associated with the backup server 214. The backup server 214 cooperates with the agent 206 and with agents associated with the clients 226 to generate backups 218. The backups 218 are associated with the clients 202 and 226. The storage 216 may be a cloud based storage, a datacenter, a disk array, network based storage, or the like or any combination thereof. Further, the storage 216 may be geographically distributed.

In this example, the agent 206 and agents associated with the clients 226, the backup server 214, and the storage 216 is an example of a centralized backup system. The backup server 214 manages the backups 218 and may perform de-duplication and other functions. When a restore operation is performed, the backup server 214 can cooperate with the agent 206 to identify and restore a specific backup from among the backups 218. The backups 218 can include full backups, incremental backups, and other types of backup configurations.

FIG. 2 also illustrates a standalone backup system 230, which is illustrated as the data backup device 220. The data backup device 220 is, in one example, associated with the client 208. The data backup device 220 may include storage 224 for storing backups 222 of data associated with the client 208. The data backup device 220 may be direct attached storage with respect to the client 208. The data backup device 220 could also be connected to other devices and may or may not be generally available on the network 200.

In this example, an agent 212 associated with the client 208 is responsible for generating a backup of the data of the client 208 that may be stored on the storage 210. The agent 212 may reside on the client 208. Alternatively, the agent 212 may reside on the data backup device 220. In either case, the backups 222 are backups of the client 208. The data backup device 220 may also perform other functions such as de-duplication once the data has been received from the client 208.

In one example, the backups 222 may be migrated 224 to the centralized backup system represented by the backup server 214 and the storage 216. When the backups 222 (or selected backups included in the backups 222) are migrated, the files or other content (the data) included in the migrated backups may be virtually replicated. Virtually replicating a file, in one example, generates a link back to the original file.

As a result, the backup server or the centralized backup system will be presented with or will generate a link to the actual files or data. The link provided to the backup server 214 may look and behave as if it were a file with the name and location that is required by the backup server 214. Advantageously, the backups 222 (or portions or subsets thereof) can be migrated to the centralized backup system 228 without having to copy the actual data in a copy operation. The data (e.g., files or content) can remain on the storage 224 and still be part of the backups 218. In fact, the backups 218 and the backups 222 may be stored on the same storage device or storage array or may be stored on different storage devices or storage arrays. The location may depend on the configuration of the network 200 and/or the configuration of the backup systems 228 and 230. Typically, the storage 224 is local to the network. The storage 216, however, may be part of a datacenter or part of the cloud and may not necessarily be local with respect to the network 200.

In one example, the links involved in the migration are maintained and/or generated by the standalone backup system 230. During the migration, the standalone backup system 230 provides the links to the centralized backup system 228 and the links are incorporated into the backups 218 as files. The actual data remains on the storage 224.

During a migration of the backups 222, the data backup device 220 or, more generally, the standalone backup system 230 may present the centralized backup system with a file system or other representation of the backups 222 or of the data in the backups 222. If the backups 218 are also stored on the same storage (e.g., the storage 224) as the backups 222, the files or data being migrated appear in a new directory. The data backup device 220 can present two files or data while using the same blocks of data on the storage 224. The new directory that is part of the backups 218 is linked to the same data. The backups 222 can be migrated without moving the actual data or corresponding blocks of data on the physical storage. Migration of the backups 222 can be performed regardless of whether the backups 222 are de-duplicated.

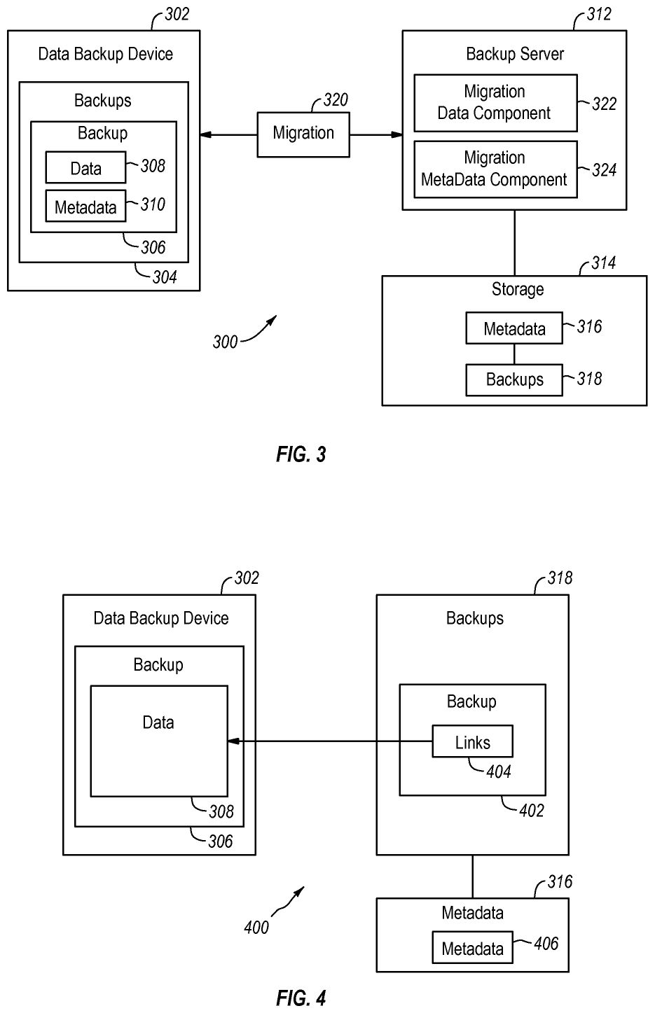

FIG. 3 illustrate an example of a system that is configured to migrate backup data from a standalone backup system to a centralized backup system. FIG. 3 illustrates a data backup device 302 (an example of a standalone backup system) and a backup server (which is part of a centralized backup system). The data backup device 302 maintains backups 304 of a at least one client. FIG. 3 also illustrates an example backup 306. The backup 306 typically includes data 308 and metadata 310.

The data 308 corresponds to the files (documents, video, images, database, text, executables, etc.) of a client that has been backed up. The metadata 310 includes indexing information that relates to or described the data 308 in one example. The indexing information describes the content of the data 308. The indexing information may describe or identify each file (e.g., name, size, type), a location of each file (on the client and/or in the storage of the data backup device), a timestamp, a path name, a client name or identifier, or the like. The metadata may also include data blogs or data that can be customized by the application performing the backup.

In one example, the metadata 310 or indexing information is stored separately from the data 308. The metadata 310 may be stored in a first database and the data 308 in a second database. The metadata 310 may even be stored on a different device.

Similarly, the backup server 312 is associated with storage 314. The storage 314 contains backups 318 that is associated with metadata 316. When a backup is generated by the backup server 312 operating in conjunction with an agent on a client, the metadata and data for the backup are added to the backups 318 and the metadata 316.

FIG. 3 further illustrates an example of backup migration 320. Migration 320 includes migrating the backup 306 such that the backup 306 becomes a part of the backup 318 and such that the metadata 310 is integrated with the metadata 316. Migration 320 can be initiated by a client, by the backup server 312, by the data backup device 302, by a user, according to a predetermined schedule, or the like.

In one example, the migration 320 is performed by a migration data component 322 and a migration metadata component 324. The components 322 and 324 may reside on and be instantiated by the backer server, an agent on the client, or the data backup device 320. The components 322 and 324 may be part of an agent residing on a client in one example.

The migration metadata component 324 migrates the metadata 310 and incorporates the metadata 310 into the metadata 316. This procedure may include a copy operation that copies the metadata 310 into the metadata 316. The migration metadata component 324 may also manage the details of incorporating the metadata 310 into the metadata 316.

The migration data component 322 migrates the data 308 to the backups 318 or, more specifically, to the data associated with the backups 318. In one example, the data 308 is not copied or moved during the migration operation. As a result, the data 308, which resides on storage of the data backup device 302 before the migration operation, remains on the storage of the data backup device 302 after the migration operation.

FIG. 4 further illustrates the migration operation or process of migrating a backup from a data backup device to a centralized backup system. When a migration operation is initiated, the backup (or backups) to be migrated are identified. FIG. 4 illustrates that the backup 306 has been selected for migration to the centralized backup system.

The backup 306, as shown in FIG. 3 and, is associated with data 308 and metadata 310. During the migration, the migration metadata component 324 migrates the metadata 310 to the metadata 316. FIG. 4 illustrates that the metadata 406 (which is the metadata 310 after migration) has been incorporated into the metadata 316. As previously stated, this may include copying the metadata 310 and writing the metadata 406 into the metadata 316. In one example, the metadata 310 maintained by the data backup device 302 is not deleted.

The backup 306 can be restored in different methods after the backup 306 is migrated. The backup 306 can be restored either by the data backup device 302 or by the backup server 312. The agent on the client associated with the restore operation may be configured to interact with both the data backup device 302 and with the backup server 312.

During the migration, the migration data component 312 migrates the data 308 to the backups 318. The backup 306, after migration, becomes the backup 402 in the backups 318. However, it may not be necessary to actually copy the data 308 from the data backup device 302 to the backups 318. In one example, the backup 402 is populated with links 404. In one example, the migration data component 322 may present the backup server with the links. In one example, the links 404 are generated by the data backup device 302 and presented to the migration data component 312 during migration of the data. More specifically, the data backup device 302 maintains the data 308 and any links to the data. This enables the data backup device 302 to present a file system to the migration data component or to the centralized backup system. When the actual data is restored or accessed, the link can be interpreted by the data backup device 302 to access the actual data. When the backup 404 from the centralized backup system is restored, the link is retrieved. Retrieving the link results in an access to the actual 308 on the data backup device 302 in one example.

The links 404 may be configured to look and behave like a file with a name and location that may be required (or other information) by the centralized backup system. As a result, the migration operation can consume less time and cause less interference with the operation of the data backup device 302.

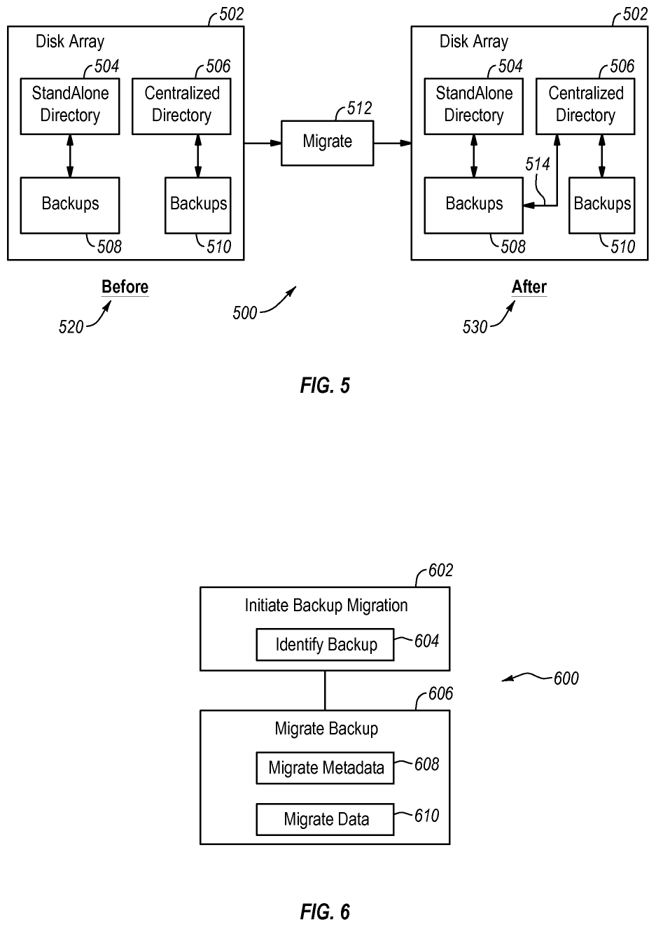

FIG. 5 is an example of backup data before migration and after migration. The backup data before migration (520) may be stored on a disk array 502. The disk array 502 may be storage that is available to a client or that is available over a network to multiple clients.

In the disk array 502, a standalone directory 504 exists that is associated with backups 508. In other words, the standalone directory 504 many contain the backups 508 for a client. The disk array 502 may also include centralized directory 506 that is associated with backups 510.

In block 512, the backups 508 (or portion thereof) are migrated to the backups 510. In one example the backups 510 after migration (530) are linked to the centralized directory 506, which is associated with the centralized backup system.

FIG. 5 illustrates that the same disk array 502 may include both the backups of a standalone backup system and the backups of a centralized backup system. During migration, the centralized backup system is linked to the data of the standalone backup system. Of course, the different storage devices may be involved. The metadata, as previously stated, may actually be copied into the metadata maintained by the centralized backup system.

After migration is complete, the data and backup of the standalone backup system is not necessarily deleted. As a result, a backup that has been migrated can be restored by the standalone backup system or by the centralized backup system. In addition, because the links look and/or act like a file from the perspective of the centralized backup system, the backups 510 can be de-duplicated. Plus, the backups 508 may already be de-duplicated to some extent before migration.

FIG. 5 further illustrates that the standalone backup system (which may include the disk array 502) can present two files in its file system (via the stand alone directory 504 and the centralized directory 506 while using the same data (the backups 508).

FIG. 6 illustrates an example of a method for migrating a backup from one backup system to another backup system. More specifically, FIG. 6 illustrates a method 600 for migrating a backup from a standalone backup system to a centralized backup system.

The method 600 may begin by initiating 602 a backup migration. This can include identifying 604 a backup to migrate. The migration can include a single backup of a client, multiple backups of a single client, or backups of multiple clients. Because the backups are stored on a standalone backup system, the backups of different clients may not be related and may not be de-duplicated with respect to each other.

After the backup has been identified, the method 600 includes migrating 606 the backup to another backup system such as the centralized backup system. Migrating 606 the backup can include migrating 608 the metadata associated with the identified backup and migrating 610 the data (e.g., files or other content) associated with the identified backup.

Migrating 608 the metadata associated with the identified backup can include copying the metadata and incorporating the metadata into the metadata or indexing information of the centralized backup server. The metadata being migrated may remain intact and is not deleted in one example. Thus, the centralized backup system and the standalone backup system may each maintain a copy of the metadata.

Migrating 610 the data can include establishing or creating links that are incorporated into the backups of the centralized backup server. The links may be be generated by the standalone backup system and presented to the centralized backup system, which interprets the link like other data that has been backed up to the centralized backup system. In one example, migrating 610 the data can include presenting the centralized backup system with the links to the files of the backup that look and act as if the links were files. The links are configured to conform to the requirements of the centralized backup server. The links may be generated from the metadata and may not require that the data stored in the standalone backup system be scanned in order to generate the links Advantageously, this can enhance the availability of the standalone backup system (or of the storage device) when a backup is migrated.

In one example, migrating 608 the metadata is performed separately from migrating 610 the data. As previously stated, the metadata may be stored separately from the data of the backup.

Embodiments of the present invention may comprise or utilize a special purpose or general-purpose computer including computer hardware, such as, for example, one or more processors and system memory, as discussed in greater detail below. The various components and modules identified herein may be executed by a processor on a computing device.

Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media.

Computer storage media (devices) includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to computer storage media (devices) (or vice versa).

Computer-executable instructions include, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code.

Those skilled in the art will appreciate that the embodiments of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, tablet devices and the like. Embodiments of the invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modulates running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or target virtual machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for migrating a backup from a standalone backup system to a centralized backup system, the method comprising:
generating a backup of production data associated with a client by the standalone backup system, wherein the backup of the production data is stored in the standalone backup system, wherein the backup of the production data includes files;
migrating the backup of the production data from the standalone backup system to the centralized backup system without copying the files in the backup to the centralized backup system, wherein the standalone backup system is separate and independent of the centralized backup system, wherein the files included in the backup of the production data are virtually replicated during the migration such that the centralized backup system is presented with links to the files in the backup of the production data, wherein the links look and act like files from the perspective of the centralized backup system, wherein the links behave as if they were files with a name and a location as required by the centralized backup system; and
incorporating the backup from the standalone backup system into other backups maintained by the centralized backup system without copying the files in the backup of the production data associated with the links to the centralized backup system,
incorporating the links into the other backups as files,
wherein the backup incorporated into the backups maintained by the backup server is configured to be restored by the standalone backup system and configured to be restored by the centralized backup system.

2. The method of claim 1, wherein the standalone backup system is directly connected to the client and wherein the backup of the client is independent of backups of other clients.

3. The method of claim 1, further comprising:
migrating the backup to the centralized backup server by physically copying the data; and
migrating the metadata to the centralized backup system.

4. The method of claim 3, wherein migrating the metadata further comprises copying the metadata of the backup from the standalone backup system to the centralized backup system.

5. The method of claim 4, further comprising incorporating the metadata from the standalone backup system into the metadata maintained by the centralized backup system.

6. The method of claim 3, wherein migrating the data further comprises presenting the links to the files to the centralized backup system.

7. (canceled)

8. The method of claim 4, further comprising maintaining the metadata of the backup in the standalone backup system.

9. The method of claim 4, further comprising restoring the backup to the client from either the standalone backup system or the centralized backup system.

10. A non-transitory physical storage device having stored therein computer-executable instructions that, when executed by one or more hardware processors of a computing system, migrate a backup from a backup storage device of a standalone backup system to a storage of a backup server, wherein migrating the backup comprises:
generating a backup of production data associated with a client, wherein the backup of the production data is stored in the backup storage device of the standalone backup system, wherein the backup includes indexing information and data, the data of the backup including files, wherein the standalone backup system is separate from the backup server;
migrating the indexing information to the backup server, wherein the indexing information associated with the backup is incorporated into indexing information associated with and maintained by the backup server;
migrating the data to the storage of the backup server without copying the files in the backup to the backup server by:
generating links to the data stored at the standalone backup system;
presenting the links to the files included in the backup of the client stored in the backup storage device of the standalone backup system to the backup server, wherein the backup is incorporated into the backups maintained by the backup server at least by incorporating the links into the backups such that the backups maintained by the backup server are associated with multiple clients including the client associated with the migrated backup, wherein the files included in the backup and associated with the links are not copied to the backups maintained by the backup server and wherein the backups are maintained on the backup system,
wherein the links are incorporated into the other backups maintained by the backup server and are configured to behave as if they were files with a name and a location as required by the backup server,
wherein the backup incorporated into the backups maintained by the backup server is configured to be restored by the standalone backup system and configured to be restored by the centralized backup system.

11. The physical storage device of claim 10, wherein the indexing information is stored separately and independently of the data of the backup.

12. The physical storage device of claim 10, wherein migrating the indexing information to the backup server includes copying the indexing information from the backup storage device to the storage of the backup server.

13. The physical storage device of claim 10, wherein the data of the backup is virtually replicated in the storage of the backup server.

14. The physical storage device of claim 10, wherein the links look and act like files from a perspective of the backup server.

15. The physical storage device of claim 10, wherein the backup is restorable by either the standalone backup system or the backup server after migration to the backup server.

16. A device configured for migrating a backup from a standalone backup system to a centralized backup system, the device comprising:
one or more hardware processors;
a data storage configured to store backups of files of a client, wherein the backups of the files are generated from production data of the client; and
a migration data component configured to migrate a backup of files selected from the backups of the file of the client to backups of files maintained by the centralized backup system without copying the files to the centralized backup system, wherein the migration data component migrates the backup of files by generating links to the files included in the backup and providing the centralized backup system with the links to the files instead of the files, wherein the centralized backup system incorporates the links to the files of the backup into the backups maintained by the centralized backup system such that the backups maintained by the centralized backup system include files and links to files, wherein the links in the backups maintained by the centralized backup system are configured to look and act like files for the centralized backup system, wherein the links behave as if they were files with a name and a location as required by the centralized backup system, and
a migration metadata component configured to migrate metadata of the backup to metadata maintained by the centralized backup system, wherein the migration metadata component copies the metadata of the backup into the metadata maintained by the centralized backup system such that the metadata maintained by the centralized backup system are associated with multiple clients including the client,
wherein the links are incorporated into the other backups maintained by the centralized backup system as files,
wherein the backup maintained by the centralized backup system is configured to be restored by the standalone backup system and configured to be restored by the centralized backup system.

17. The device of claim 16, wherein the migration data component and the migration metadata component are resident on a backup server included in the centralized backup system or on a backup storage device of the standalone backup system.

18. The device of claim 17, wherein the links are configured to be used by the centralized backup system such that the links point to the data stored on the backup storage device.

19. The device of claim 17, further comprising an agent, wherein the agent is operable to communicate with the client, the backup server, the migration data component and the migration metadata component, wherein the metadata includes indexing information for the data.

20. The device of claim 19, wherein the standalone backup system is directly connected to the client, wherein the agent is configured to at least one of:
backup the data of the client to the standalone backup system;
backup the data of the client to the centralized backup system by coordinating with a backup server; and
restore the migrated backup from either the centralized backup system or the standalone backup system.
